(19) United States
(12) Patent Application Publication
(10) Pub. No.: US 2022/0108393 A1
(43) Pub. Date: Apr. 7, 2022

(54) ARTIFICIAL INTELLIGENCE NEGOTIATION SYSTEM AND METHOD

(71) Applicant: WEMATCH.LIVE R&D LTD., Tel Aviv (IL)

(72) Inventor: Pasquale CATALDI, London (GB)

(73) Assignee: WEMATCH.LIVE R&D LTD., Tel Aviv (IL)

(21) Appl. No.: 17/428,021

(22) PCT Filed: Feb. 3, 2020
(86) PCT No.: PCT/IB2020/050842

§ 371 Date: Aug. 3, 2021

Related U.S. Application Data
(60) Provisional application No. 62/800,511, filed on Feb. 3, 2019.

(51) Int. Cl. G06Q 40/04

(52) U.S. Cl. CPC G06Q 40/04

(57) ABSTRACT

A computer-implemented method of negotiating a trade of a product or a service between a buyer and a seller, the method including receiving from a buyer computing device a bid associated with the product or service, assigning to the bid a trade spread based on a predetermined criteria, receiving from one or more seller computing devices offers associated with the product or service, and classifying each of the offers lying within the trade spread as a tradeable offer. The method additionally includes transmitting the buyer bid and each tradeable offer to the buyer computing device and to each seller computing device with a tradeable offer, automatically displaying the buyer bid and each tradeable offer on the buyer computing device and on each seller computing device with a tradeable offer, and tracking the time the buyer bid and a tradeable offer most approximating the buyer bid are displayed on the buyer computing device and on each seller computing device with a tradeable offer.

### CROSS-REFERENCE TO RELATED APPLICATIONS

This application claims the benefit of priority from U.S. Provisional Patent Application No. 62/800,511 filed 3 Feb. 2019, the contents of which are incorporated herein by reference in their entirety.

### FIELD OF THE INVENTION

The present invention, in some embodiments thereof, relates to artificial intelligence systems, and, more particularly, but not exclusively, to an artificial intelligence system and method for performing trading negotiations.

### BACKGROUND OF THE INVENTION

Trading may generally be defined as the act of buying, selling or exchanging products or service. Technological advancements, with time, have allowed trading to evolve to a state where products and/or services may be sold on-line and may be equally purchased on-line through on-line platforms.

One sector which has seen a great advance in on-line trading is the stocks and securities investment sector. Prior to the Internet, investors had to place an order through a stockbroker, in person or via telephone. The brokerage firm then entered the order in their system, which was linked to trading floors and exchanges. With the advent of the Internet, individuals and traders may now buy and sell securities over an electronic network using an on-line trading platform. The online trading platform acts as the hub, allowing investors to purchase and sell such securities as fixed income, equities/stock, options, and mutual funds. Included with the platform are tools to track and monitor securities, portfolios and indices, as well as research tools, real-time streaming quotes and up-to-date news releases.

Some on-line trading platforms maintain both buyers and sellers anonymous in order to prevent their entering into direct negotiation, potentially bypassing an intermediary. One such platform is described in US 2010/0005030 to DePetris et al. which discloses “A computer program provides a screen-based interface enabling anonymous negotiation between a buyer and a seller. Parties wishing to trade enter values into fields of a screen-based interface, thereby creating a trading interest, and may select from terms associated with each of the fields to augment the trading interest. The parties may also specify counter-party filtering criteria in the trading interest. The computer program then displays to the creator of the trading interest any previously entered trading interests that might result in a trade, and that satisfy the counter-party filtering criteria, if any. The computer program also displays the new trading interest to the creators of the previously entered trading interests. Two of the parties may agree to negotiate using structured messages that maintain their anonymity. The identities of the counter-parties need not be known to each other as, after a trade agreement is reached, a central clearing party becomes the counter-party to each of the parties via a novation”.

### SUMMARY OF THE PRESENT INVENTION

There is provided, in accordance with an embodiment of the present invention, a computer-implemented method of negotiating a trade of a product or a service between a buyer and a seller, the method including receiving from a buyer computing device a bid associated with the product or service, assigning to the bid a trade spread based on a predetermined criteria, receiving from one or more seller computing devices offers associated with the product or service, and classifying each of the offers lying within the trade spread as a tradeable offer. The method additionally includes transmitting the buyer bid and each tradeable offer to the buyer computing device and to each seller computing device with a tradeable offer, automatically displaying the buyer bid and each tradeable offer on the buyer computing device and on each seller computing device with a tradeable offer, and tracking the time the buyer bid and a tradeable offer most approximating the buyer bid are displayed on the buyer computing device and on each seller computing device with a tradeable offer.

In some embodiments, the method includes broadcasting a message that a negotiation is ongoing between an anonymous buyer and an anonymous seller to a plurality of buyer and seller computing devices when the tracked time reaches a predetermined time.

In some embodiments, the method includes displaying a message associated with the broadcasted message on the buyer computing device and on each seller computing device with a tradeable offer.

In some embodiments, the method includes trade spread includes a predetermined price range associated with a specific product or service.

In some embodiments, the method includes broadcasting the buyer bid and each tradeable offer to a plurality of buyer and seller computing devices when the tracked time reaches a predetermined time.

In some embodiments, the method includes resetting the tracked time when a new tradeable offer is received which is closer to the buyer in the tradeable spread relative to previously received tradeable offers.

In some embodiments, the method includes broadcasting the buyer bid and each tradeable offer to a plurality of buyer and seller computing devices when a tradeable offer matches the buyer bid.

In some embodiments, the method includes maintaining anonymity of the buyer computing device and the seller computing devices.

There is provided, a negotiation system including a negotiation engine and a non-transitory computer readable medium storing instructions executable in a negotiation engine and causing the negotiation engine to perform operations which include receiving from a buyer computing device a bid associated with the product or service, assigning to the bid a trade spread based on a predetermined criteria, receiving from one or more seller computing devices offers associated with the product or service, and classifying each of the offers lying within the trade spread as a tradeable offer. The operations additionally include transmitting the buyer bid and each tradeable offer to the buyer computing device and to each seller computing device with a tradeable offer, automatically displaying the buyer bid and each tradeable offer on the buyer computing device and on each seller computing device with a tradeable offer, and tracking the time the buyer bid and a tradeable offer most approximating the buyer bid are displayed on the buyer computing device and on each seller computing device with a tradeable offer.

There is provided a non-transitory computer readable medium for use in negotiations and storing instructions executable in a negotiation engine and causing the negotiation engine to perform operations which include receiving from a buyer computing device a bid associated with the product or service, assigning to the bid a trade spread based on a predetermined criteria, receiving from one or more seller computing devices offers associated with the product or service, and classifying each of the offers lying within the trade spread as a tradeable offer. The operations additionally include transmitting the buyer bid and each tradeable offer to the buyer computing device and to each seller computing device with a tradeable offer, automatically displaying the buyer bid and each tradeable offer on the buyer computing device and on each seller computing device with a tradeable offer, and tracking the time the buyer bid and a tradeable offer most approximating the buyer bid are displayed on the buyer computing device and on each seller computing device with a tradeable offer.

In some embodiments, the instructions cause the negotiation engine to broadcast a message that a negotiation is ongoing between an anonymous buyer and an anonymous seller to a plurality of buyer and seller computing devices when the tracked time reaches a predetermined time.

In some embodiments, the instructions cause the negotiation engine to display a message associated with the broadcasted message on the buyer computing device and on each seller computing device with a tradeable offer.

In some embodiments, the instructions cause the negotiation engine to broadcast the buyer bid and each tradeable offer to a plurality of buyer and seller computing devices when the tracked time reaches a predetermined time.

In some embodiments, the instructions cause the negotiation engine to reset the tracked time when a new tradeable offer is received which is closer to the buyer in the trade spread relative to previously received tradeable offers.

In some embodiments, the instructions cause the negotiation engine to broadcast the buyer bid and each tradeable offer to a plurality of buyer and seller computing devices when a tradeable offer is the same as the buyer bid.

In some embodiments, the instructions cause the negotiation engine to maintain anonymity of the buyer computing device and the seller computing devices.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 schematically illustrates a block diagram of an exemplary axis negotiation system (AINS) which may be used to practice the teachings disclosed herein, according to an embodiment of the present invention;

FIG. 2 schematically illustrates the negotiation engine (NE) in the AINS, according to an embodiment of the present invention;

FIG. 3 schematically illustrates an exemplary layout of the PUBLIC MARKET display section and of the AXE ROOM display section in the graphics unit interface (GUI) which may be used with all AINS user computing devices, according to an embodiment of the present invention;

FIG. 4A schematically illustrates the operation of the AINS in a first scenario of an exemplary first trading session which includes negotiations between participants in an Axe Room, as visualized on the GUI of a first participant, according to an embodiment of the present invention;

FIG. 4B schematically illustrates the operation of the AINS in a second scenario of the exemplary first trading session which includes negotiations between participants in the Axe Room, as visualized on the GUI of a second participant, according to an embodiment of the present invention;

FIG. 4C schematically illustrates the operation of the AINS in a third scenario of the exemplary first trading session which includes negotiations between participants in the Axe Room, as visualized on the GUI of the first participant and a third participant, according to an embodiment of the present invention;

FIG. 4D schematically illustrates the operation of the AINS in a fourth scenario of the exemplary first trading session which includes negotiations between participants in the Axe Room, as visualized on the GUI of the first participant and the third participant, according to an embodiment of the present invention;

FIG. 4E schematically illustrates the operation of the AINS in a fifth scenario of the exemplary first trading session which includes negotiations between participants in the Axe Room, as visualized on the GUI of the first participant and the third participant, according to an embodiment of the present invention;

FIG. 4F schematically illustrates the operation of the AINS in a sixth scenario of the exemplary first trading session which includes negotiations between participants in the Axe Room, as visualized on the GUI of the first participant, the second participant, and the third participant, according to an embodiment of the present invention;

FIG. 4G schematically illustrates the operation of the AINS in a seventh scenario of the exemplary first trading session which includes negotiations between participants in the Axe Room, as visualized on the GUI of the first participant, the second participant, the third participant, and a fourth participant, according to an embodiment of the present invention;

FIG. 4H schematically illustrates the operation of the AINS in an eighth scenario of the exemplary first trading session which includes negotiations between participants in the Axe Room, as visualized on the GUI of all the system users, according to an embodiment of the present invention;

FIG. 5A schematically illustrates the operation of the AINS in a first scenario of an exemplary second trading session which includes negotiations between participants in an Axe Room, as visualized on the GUI of a first participant, according to an embodiment of the present invention;

FIG. 5B schematically illustrates the operation of the AINS in a second scenario of the exemplary second trading session which includes negotiations between participants in the Axe Room, as visualized on the GUI of the first participant and a second participant, according to an embodiment of the present invention;

FIG. 5C schematically illustrates the operation of the AINS in a third scenario of the exemplary second trading session which includes negotiations between participants in the Axe Room, as visualized on the GUI of the first participant, the second participant, and a third participant, according to an embodiment of the present invention;

FIG. 5D schematically illustrates the operation of the AINS in a fourth scenario of the exemplary second trading session which includes negotiations between participants in the Axe Room, as visualized on the GUI of the first participant, the second participant, and the third participant, according to an embodiment of the present invention; and

FIG. 5E schematically illustrates the operation of the AINS in a fifth scenario of the exemplary second trading session which includes negotiations between participants in the Axe Room, as visualized on the GUI of the first participant, the second participant, the third participant, and a fourth participant, according to an embodiment of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Throughout the detailed description, reference may be made to entities such as users, buyers, sellers, and market players. It may be appreciated by the skilled person that, although these entities may be assumed to be humans, they may not necessarily be limited to humans and may include computer-based systems including AI systems and Machine Learning systems, among others.

In International Application No. PCT/M2019/056085 with international filing date of 16 Jul. 2019, and claiming priority from U.S. Provisional Application Ser. No. 62/698,301 filed 16 Jul. 2018, both applications common to the Applicant and their contents incorporated herein in by reference in their entirety, Applicant describes an artificial intelligence based (AI) negotiation system (AI negotiation system) which provides an on-line trading platform and includes a negotiation engine configured to assist an anonymous seller and an anonymous potential buyer close a deal by stimulating the buyer to increase the price offer on a product and correspondingly stimulating the seller to lower the price demand on the product. The negotiation engine may provide all system users with price offers made by one or more potential buyers and price demands made by one or more sellers and may selectively directly connect between sellers and potential buyers based on predetermined matching criteria, which may include a price spread, a product quantity spread, among other possible criteria.

The negotiation engine may use a dedicated graphic unit interface (GUI) to provide equal visibility and transparency to all market players (buyers and sellers) using the system, and to provide mechanisms to allow the users to negotiate with one another while remaining anonymous. The GUI may allow the market players to see the real-time trading situation in the market for a specific product or service. The GUI may additionally allow each buyer and seller to view their position in the market relative to other market players. Responsive to viewing their position in the market, the GUI may allow the market players to take real-time negotiating actions through the use of a series of action mechanisms which may allow them to improve their position, to remain in the same position, to withdraw their position, or to negotiate with counterpart market players. The action mechanisms may include action buttons which may be used to communicate actions, in real-time, publicly to all market players, or privately to the highest price seller and lowest price seller, and may be represented by displayed action notifications on the axis.

The negotiation engine may allow a buyer and a seller to privately communicate with one another, using the GUI, in order to enter into negotiations while remaining anonymous. The negotiation engine may additionally allow a buyer to privately negotiate with multiple sellers, or the inverse, to allow a seller to negotiate with multiple buyers. During the negotiations, all market players may be made aware that a negotiation is going on without their being aware of any of the details of the negotiation unless a deal is reached. When a deal is reached, the market players may be informed of the price level at which the trade was made, and the volume of the trade. Private negotiations may be conducted between a buyer offering the highest buying price (hereinafter “highest price buyer”) and a seller offering the lowest selling price (hereinafter “lowest price seller”). For example, the negotiation system may promote a private negotiation between a buyer with a buying price offer of 7 and a seller with a selling price offer of 8 if there are no buyer offers or seller offers in between. Optionally, a buyer and a seller may enter into private negotiations based on criteria other than smallest price difference, for example, if quantity amounts may be fully satisfied, among other possible negotiation criteria. The negotiation engine may additionally allow a market player to express behavior which may be displayed through the GUI to some or all the market players.

The GUI may display to all the market players a one-dimensional axis (hereinafter referred to as “axis”) wherein may be viewed all the offers may by the buyers and the sellers. The axis, which may be horizontally displayed, may be divided into two sections, a first axis section on which may be displayed all buyer offers for a specific product or service, and a second opposing section on which may be displayed all seller demand for that product or service. Alternatively, the axis may be displayed vertically or slopingly at an angle. The buyers' offers may be displayed on the first axis section according to the price value of each offer, ranked in descending order with the highest buyer price closest to the second axis section and the lowest buyer price furthest away from the second axis section. The sellers' demands may be ranked on the second axis section in ascending order with the lowest selling price closest to the first axis section and the highest selling price furthest away from the first axis section. Consequently, when displayed on the axis, the highest price buyer may be closest to the lowest price seller. It may then be readily appreciated that by displaying all buying prices and all selling prices along the axis in a ranked order, a quick view of the axis will provide a complete picture as to the position of each anonymous player in the market.

The GUI may additionally display on the axis buyer and seller information associated with each offer and which may include each buyer's and seller's price, the quantity being seeked by each buyer and the quantity offered for sale by each seller, and optionally the number of buyers and sellers at the same price levels. When there is more than one buyer or seller at a same price level, the information displayed may include that of the first buyer or seller to post a buying offer or a selling offer, respectively. Additionally displayed on the axis may be the action notifications by the users, representative of buyer and seller negotiation actions.

The GUI may additionally display to all the market players the highest buyer price offer and the lowest seller price demand and the amount of time the price offer/demand is valid (amount of time until the price offer/demand expires). For example, the highest price buyer may indicate that his or her buying offer is valid until the end of the day (EOD) while the lowest price seller may indicate that his or her demand is valid for a limited amount of time, for example, three hours.

The GUI may additionally allow the market players to input their buying offers or selling demands and may display them on the axis to all market players. It may additionally allow them to modify their offers/demands and also to enter into private negotiations with counterparts.

In the AI negotiation system, a negotiation action which may be taken by a market player, as part of a negotiation process, may be to communicate a private notification through the GUI and by means of the action buttons to the counterpart with the closest counteroffer. The private notification may only be displayed on the axis of the highest price buyer and the lowest price seller, and may not be viewed by the rest of the market players. The private notification may be in the form of an improved offer/demand and may be limited in time. Additionally, the private notification may include a “let's meet in the middle” notification which may be an offer to equally divide the price difference between the buyer and seller (divide the price difference in half). Additionally, the private action notification may include a “repeat” notification wherein during a negotiation, one of the parties may not wish to change the price and, in response to an offer from the counterparty, may display the notification indicating that the existing offer is being repeated. Additionally, the private notification may include a “last show” notification wherein one of the parties provides an offer (or improved offer) and limits the time duration of the offer, for example to 15 minutes. Additionally, the private notification may include an “are you there?” notification wherein a party willing to negotiate (or to trade) communicates a notification directed to the closest counterpart who may have previously indicated their unwillingness to continue trading on the axis to all the market players, querying if they are open to trade.

During the negotiation, the offers and counteroffers made by the negotiating buyer and seller may be displayed on their axis, but are not displayed to the rest of the market players. During the negotiation, an indication that a negotiation is ongoing may be displayed to the rest of the market players, but in order to not provide any further information associated with the private negotiation, there is no change in the position of all the market players on the axis, including that of the negotiating players. Only when a deal is reached may the GUI display on the axis of all the market players the result of the negotiations (price and quantity), or on the contrary, if a deal is not reached, may inform all the market players by removing the indication that a negotiation is ongoing. Optionally, multiple negotiations may go on between a buyer and multiple sellers or multiple buyers and one seller, with each negotiation potentially having different conditions. Optionally, a market player may enter into a private negotiation with a counterpart without first posting an offer on the axis.

The GUI may additionally allow the market players to take actions which may be displayed on the axis to the rest of the market players. An example of such an action may include a player displaying on the axis a notification that he or she cannot modify their offer. Another action may include a player displaying on the axis that, although they posted an offer/demand, they are no longer open to trade. Another action may include a player who had previously indicated that they are no longer open to trade repealing that action by indicating a new willingness to trade.

In some embodiments, the negotiation engine may include a suggestion unit which may suggest matchings between buyers and sellers. The suggestions may be based on similarity matching where the buyer may be suggested a product which is not exactly the same but may provide the same results as the product being sought by the buyer. Additionally or alternatively, the suggestions may be based on replication matching where the buyer is suggested a combination of products which will provide the same results as the product being sought by the buyer. Additionally or alternatively, the suggestions may be based on a correlation matching where the buyer is suggested a product based on a relevancy computed according to a correlation ratio calculated by historical data and/or user data, among other possible data which may be used to estimate the correlation. Optionally, the user may define the correlation conditions which may trigger a match. In U.S. patent application Ser. No. 16/630,649 filed on 13 Jan. 2020 as national phase application of International Application No. PCT/M2018/055115 with international filing date of 11 Jul. 2018, and claiming priority from U.S. Provisional Application Ser. No. 62/531,074 filed 11 Jul. 2017, all common to the Applicant and their contents incorporated herein in by reference in their entirety, the suggestion functions associated with the negotiation engine including the suggestion unit are described in greater detail.

Applicant has realized that the negotiation engine in the AI negotiation system may be configured to first connect an anonymous potential buyer and an anonymous seller whose buying price offer and selling price demand meet a predetermined criteria prior to disclosing to all system users (the Public Market) the seller's price demand and the buyer's price offer. By recognizing the prospects of the possibility of closing a deal by identifying candidates whose price offer and price demand meet the predetermined criteria, the negotiation engine additionally may coax the candidates, for example using the GUI, into negotiating by automatically placing them in a “room” where they are provided with the necessary tools to anonymously negotiate with one another. It may then be appreciated that this room, or “Axe Room” as it may be referred to hereinafter, may serve as a platform to automatically introduce potentially buying and selling candidates to one another privately, and to induce them to negotiate with one another while maintaining their anonymity.

According to an embodiment of the present invention, the negotiation engine may store one or more seller price demands without disclosing them to all the system users (the Public Market), and may additionally store one or more buyer price offers also without disclosing them to the Public Market. When a price difference between a seller and a buyer is within a predetermined range or “trade spread” (or “spread”), the negotiation engine may automatically connect the buyer and the seller (privately disclose one to the other, for example through the GUI, while maintaining their anonymity) by moving them into the Axe Room to attempt to negotiate a deal between. The negotiation engine may include a timer (Axe Room timer) and may allow the parties a predetermined amount of time to negotiate with one another inside the Axe Room (hereinafter referred to as “negotiation time”), for example, 5 or 10 minutes, after which, if a deal is not reached, the seller's price demand and the buyer's price offer are disclosed to the Public Market, optionally through the GUI. Optionally, the negotiation engine may disclose to the Public Market that a negotiation is in process inside the Axe Room following a predetermined amount of time following the start of the negotiation (hereinafter referred to as “warning time”), for example, 1 or 2 minutes after the start of the negotiation. Optionally, the disclosing of the existence of the negotiation in the Axe Room to the Public Market is due to a lack of advancement of the negotiation between the parties and/or to encourage other parties to enter the Axe Room and take part in the negotiations.

In some embodiments, in the process of the negotiation between the buyer and the seller in the Axe Room, the negotiation engine may automatically introduce a new seller and/or a new buyer into the Axe Room whose price demand or price offer, respectively, lies within the trade spread. Optionally, the price offered by the new buyer or the price demand of the new seller joining the Axe Room may be disclosed to the rest of the parties in the Axe Room (while maintaining all parties anonymity). A new negotiation due to the entry of a new buyer or seller may reset the Axe Room timer. Alternatively, the negotiation engine timer is not reset when new participants enter the negotiation. Optionally, a negotiating buyer or seller in the Axe Room may display their buyer price offer or the seller price demand, respectively, to the Public Market, optionally as part of a negotiation.

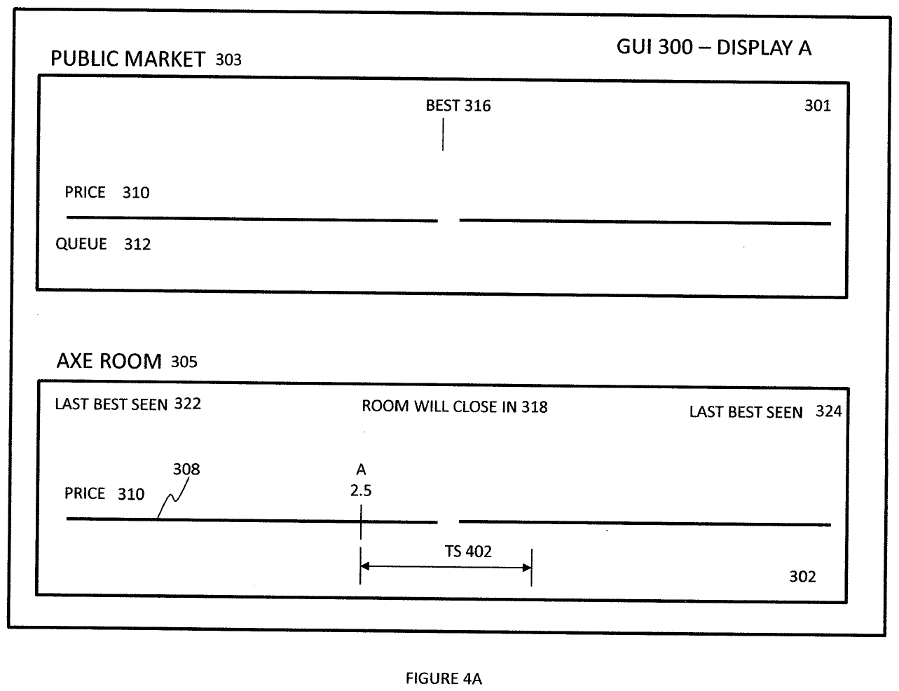

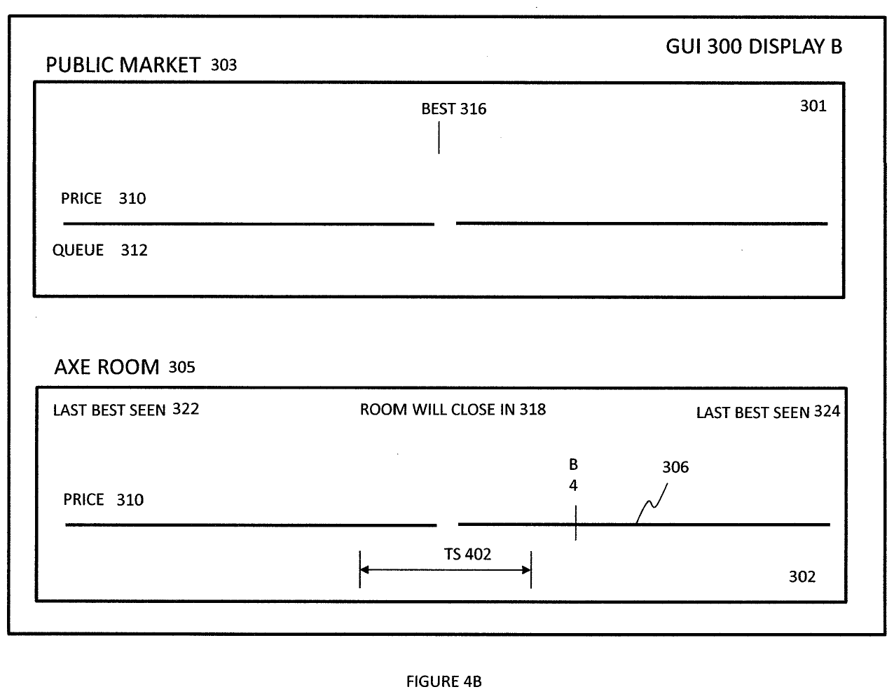

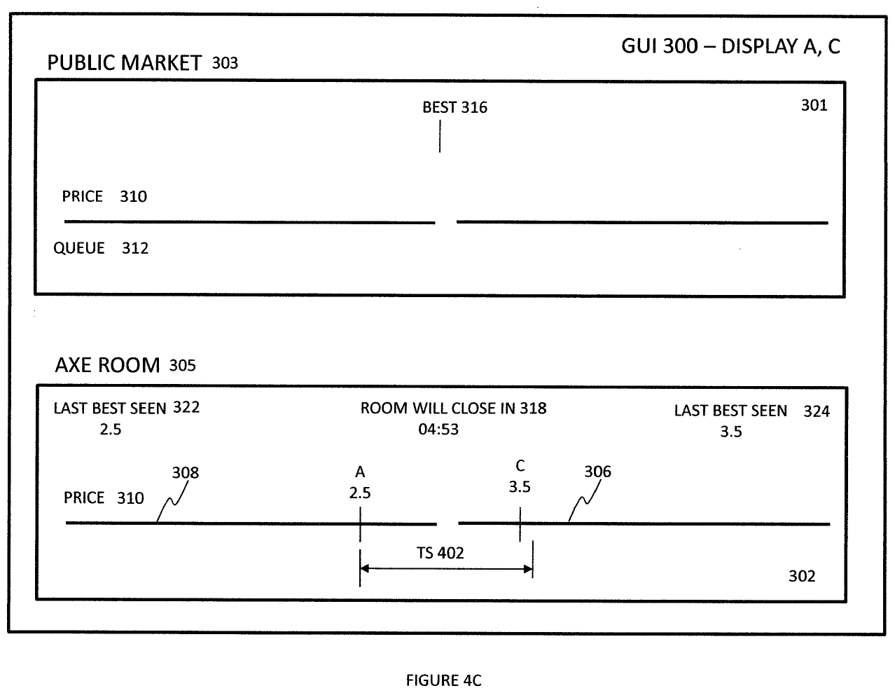

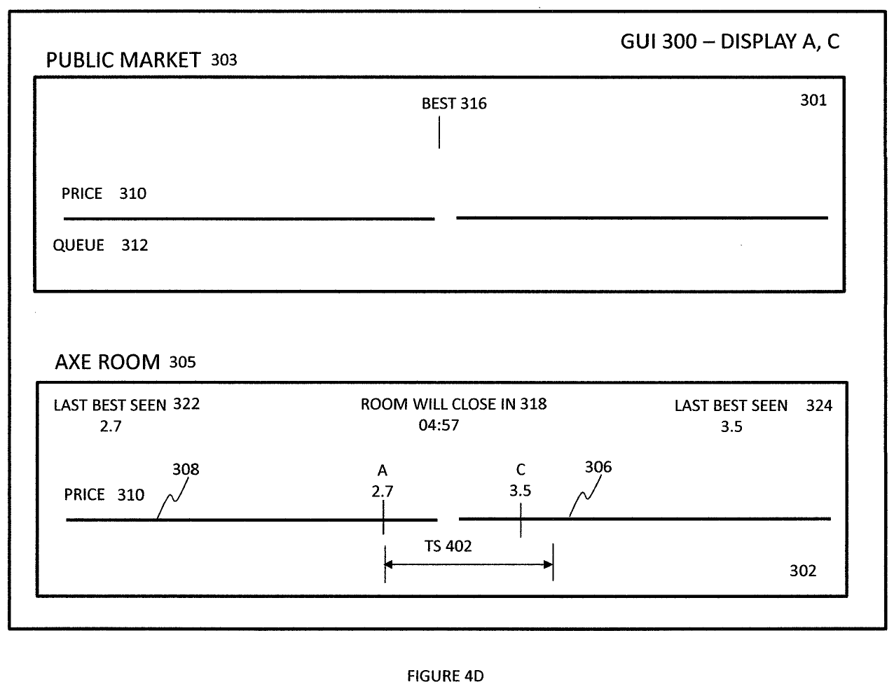

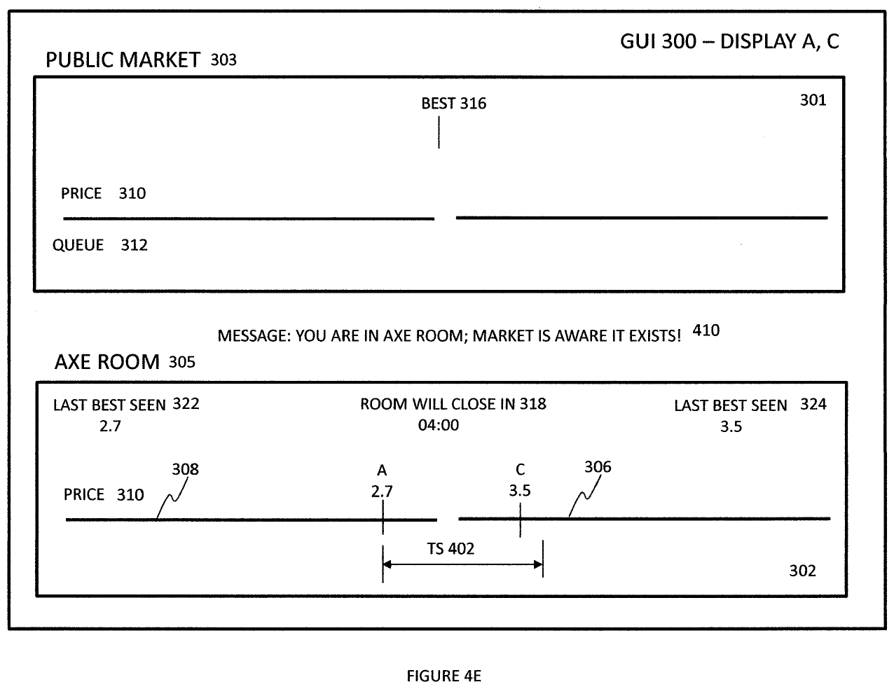

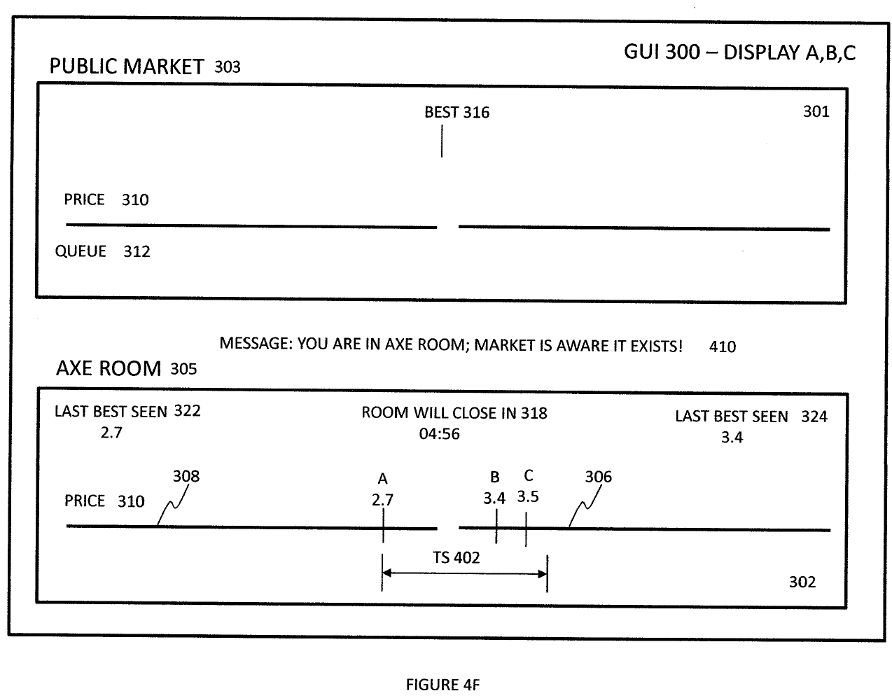

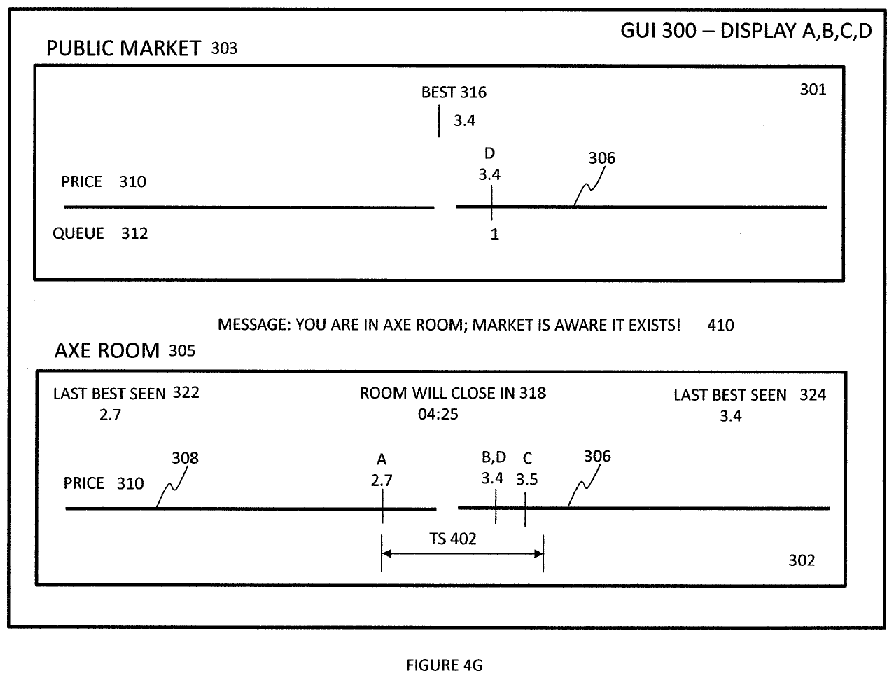

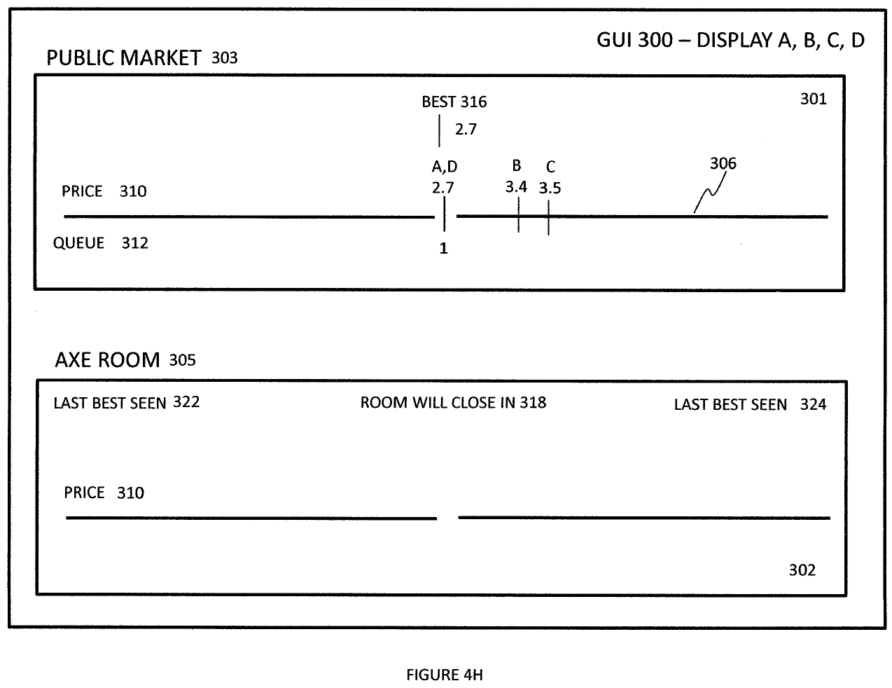

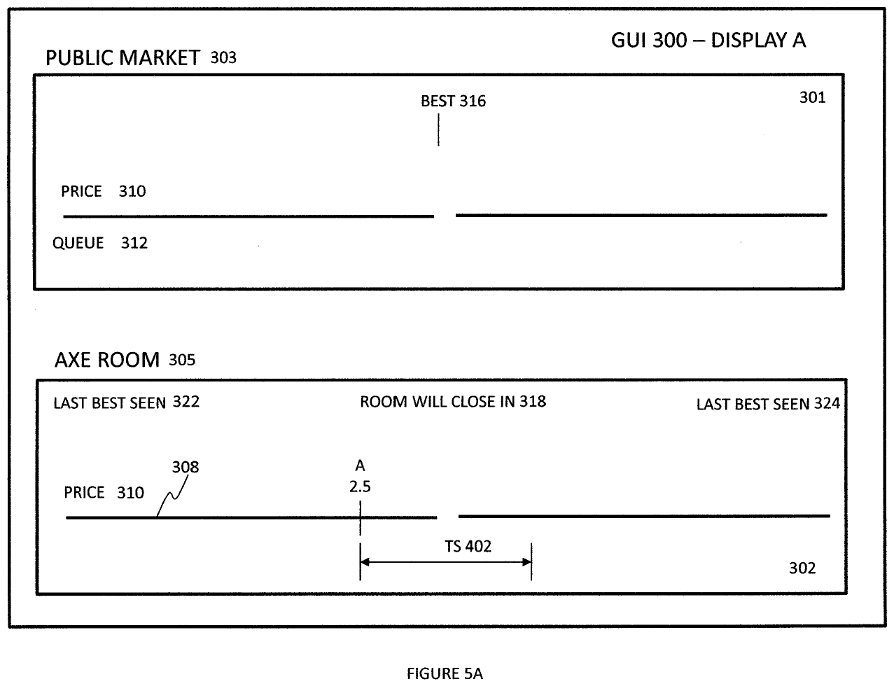

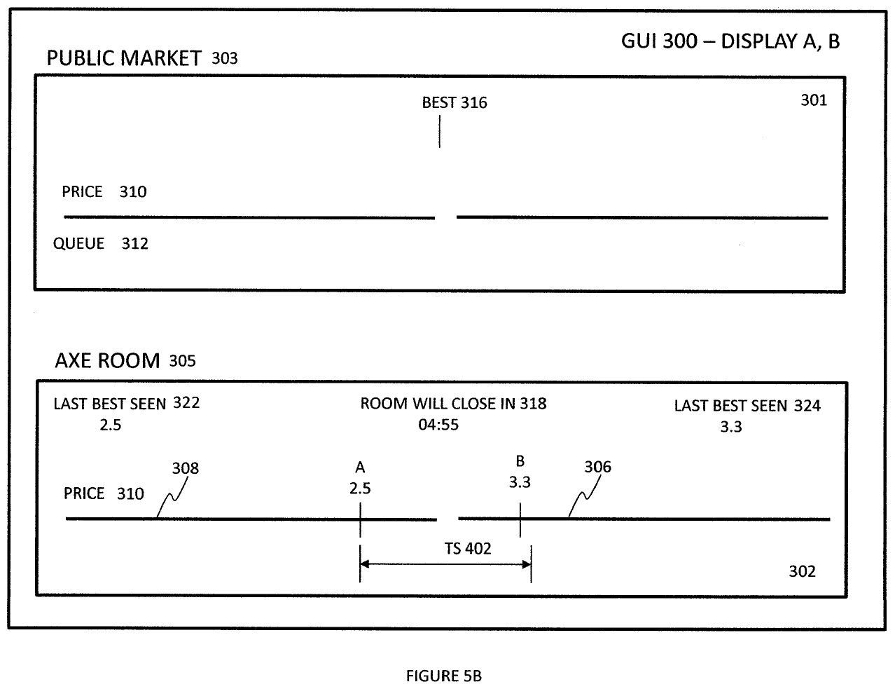

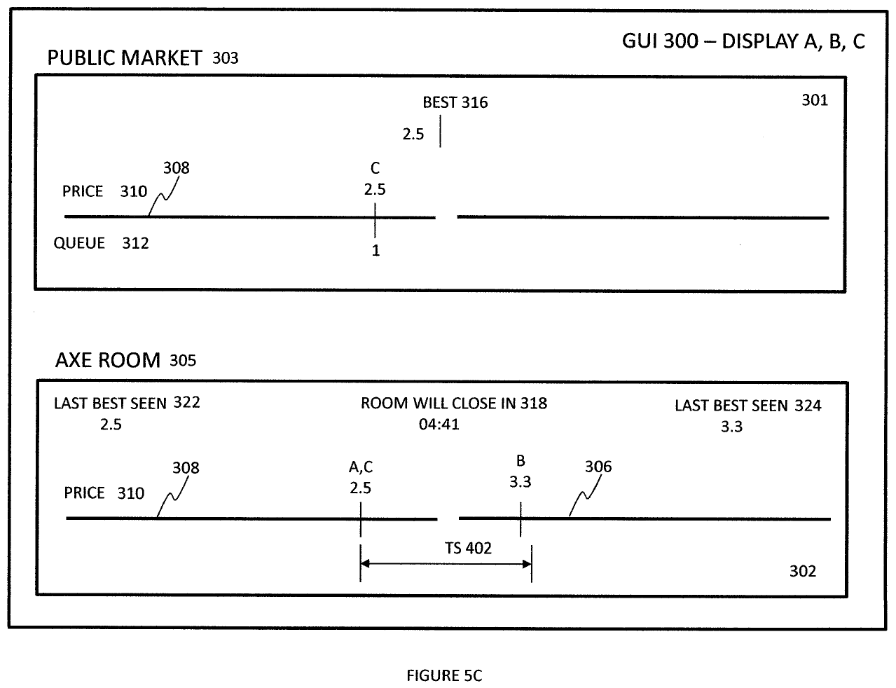

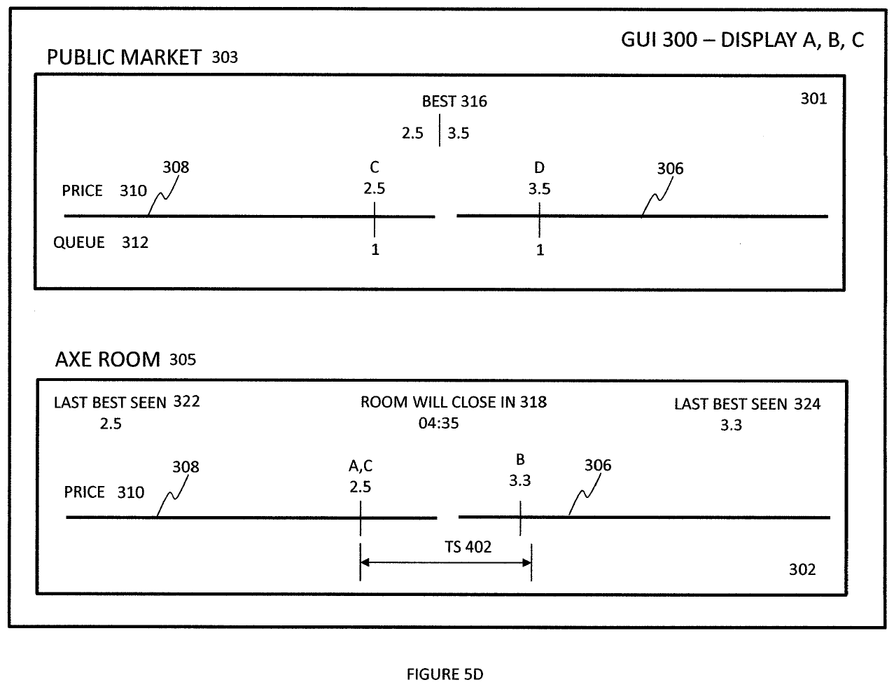

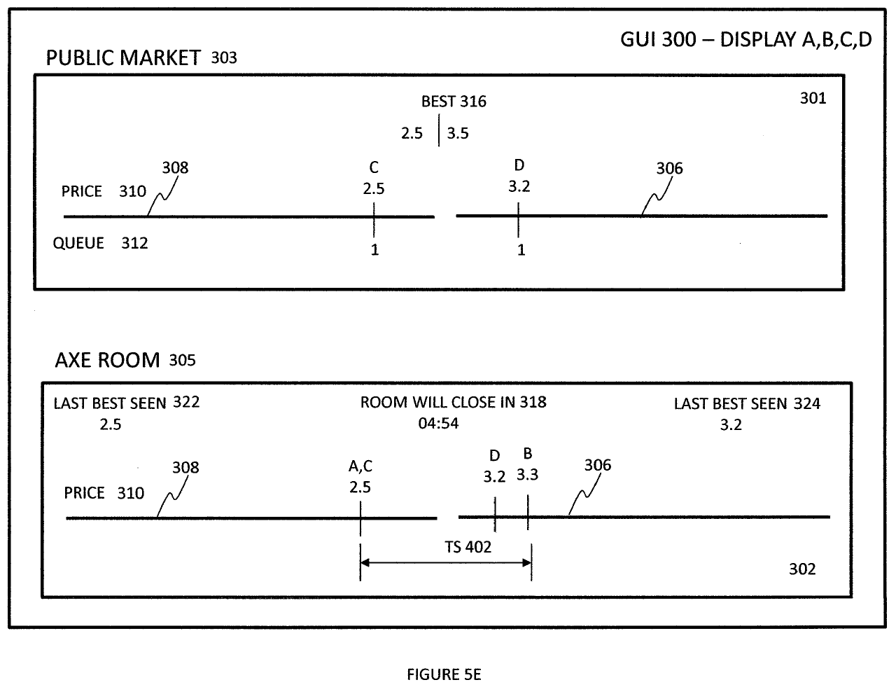

In some embodiments, AI negotiation system operation, including use of the Axe Room to attempt to close a deal between a buyer and a seller, may be shown by two exemplary trading sessions further on below. The exemplary first trading session is shown in FIGS. 4A-4H and the second exemplary trading session is shown in FIGS. 5A-5F. Both exemplary trading sessions include four participants and are therefore non-limiting, that is, the skilled person may appreciate that in a trading session any number of participants may be involved and furthermore, that the combination of actions which may be taken by the participants may reach vast numbers depending on the number of participants.

In the figures are shown a display section PUBLIC MARKET which includes an axis where seller offers and buyer offers are lined up and may be displayed to all the system users, and a display section AXE ROOM which displays events associated with the participants in the Axe Room and includes an axis where the buyer offers and seller demands are automatically and privately displayed based on their lying within a trade spread (i.e. the buyers and sellers are inside the Axe Room). The spread, which is based on predetermined criteria according to the product or service being negotiated, may be a buyer spread associated with a buyer's price offer or a seller's spread associated with a seller's price demand, optionally depending on who places the initial request in the Axe Room. A buyer price offer may lies within a seller's spread may be viewed as, and optionally referred to, as “tradeable bid” as the buyer may be allowed to negotiate and trade in the Axe Room based on the tradeable bid. Similarly, a seller price demand which lies within a buyer's spread may be viewed as, and optionally referred to, as “tradeable offer” as the seller may be allowed to negotiate and trade in the Axe Room. Buyers and sellers who are not within the trade spread are not involved in the private negotiations inside the Axe Room and may not view the AXE ROOM display section in the GUI display. Buyers and sellers involved in negotiations inside the Axe Room may have access to both the AXE ROOM display section and the PUBLIC MARKET display section but their offers may not appear in the PUBLIC MARKET display section while they appear in the AXE ROOM display section. Optionally, a buyer or a seller may request to have their price also appear in the PUBLIC MARKET display section even if shown in the AXE ROOM display section.

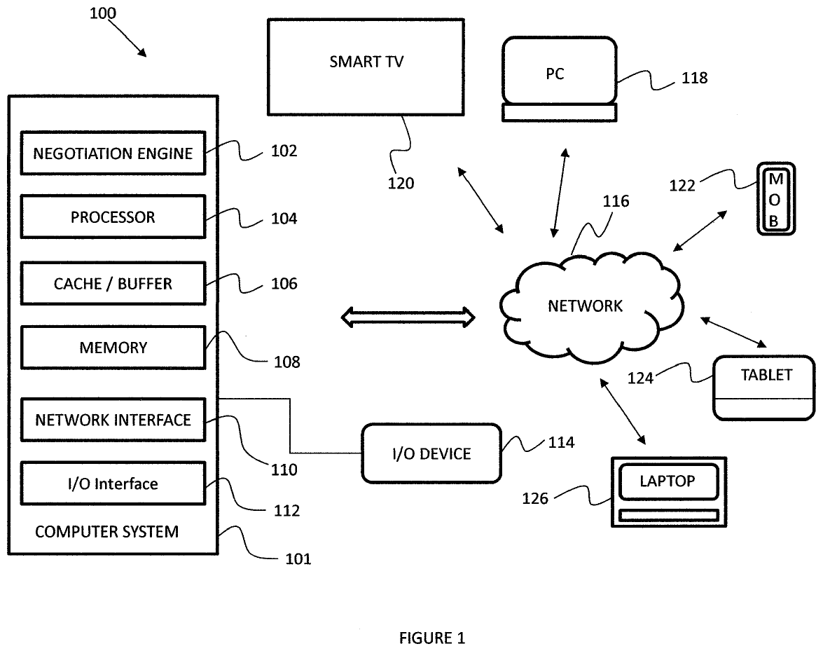

Reference is now made to FIG. 1 which schematically illustrates a block diagram of an exemplary AI negotiation system (AINS) 100 which may be used to practice the teachings disclosed herein, according to an embodiment of the present invention. AINS 100 may include a computer system 101 including a Negotiation Engine (NE) 102, a processor 104, a cache/buffer 106, a memory 108, a network interface 110, an I/O interface 112, at least one I/O device 114. ANS 100 may additionally include a plurality of computing devices, for example, computing devices which may include PCs 118, smart TVs 120, mobile phones 122, tablets 124, and laptops 126.

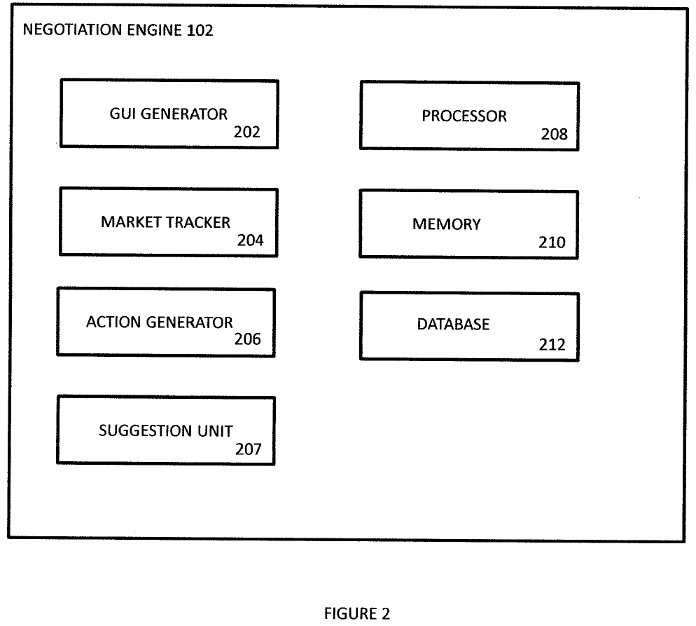

NE 102 may provide the trading platform for the buyers and sellers including the GUI used by all the market players to present their buying or selling offers on the Public Market axis and/or the Axe Room axis and to negotiate trades. The GUI may be implemented in the plurality of computing devices 118-126. The components of NE 102 and its functioning is described in greater detail hereinafter with reference to NE 200 shown in FIG. 2 and associated description.

Processor 104 may be a computing device for executing hardware instructions or software, and may include those stored in memory 108. Processor 104 may be any custom made or commercially available processor, a central processing unit (CPU), an auxiliary processor among several processors associated with computer system 101, a semiconductor based microprocessor (in the form of a microchip or chip set), a macroprocessor, or generally any device for executing instructions. Processor 104 may include a cache/buffer 106. Processor 104 may be configured to execute instructions stored within memory 108, to communicate data to and from the memory 108, and to generally control operations of computer system 101 pursuant to the instructions.

Memory 108 may include any one or combination of volatile memory elements (e.g., random access memory RAM, such as DRAM, SRAM, SDRAM, etc.) and nonvolatile memory elements (e.g., ROM, erasable programmable read only memory EPROM, electronically erasable programmable read only memory EEPROM, programmable read only memory PROM, tape, compact disc read only memory CD-ROM, disk, diskette, cartridge, cassette or the like, etc.). Moreover, memory 108 may incorporate electronic, magnetic, optical, and/or other types of storage media. Optionally, memory 108 may have a distributed architecture, where various components are situated remote from one another, but may be accessed by processor 104.

The instructions in memory 108 may include one or more separate programs, each of which may include an ordered listing of executable instructions for implementing logical functions. In the example of FIG. 1, the instructions in memory 108 may include any suitable operating system. The operating system may essentially control the execution of other computer programs and may provide scheduling, input-output control, file and data management, memory management, and communication control and related services.

Network interface 110 may serve to connect computer system 101 to a network 116. Network 116 may be an IP-based network for communication between computer system 101 and computing devices 118-126 and may transmit and receive data between the ANS and the computing devices. Optionally, network 116 may be a managed IP network administered by a service provider. Network 116 may be implemented in a wireless fashion, e.g., using wireless protocols and technologies, such as Wi-Fi, WiMAX, etc. Network 116 may also be a packet-switched network such as a local area network, wide area network, metropolitan area network, Internet network, or other similar type of network environment. Network 116 may be a fixed wireless network, a wireless local area network (LAN), a wireless wide area network (WAN) a personal area network (PAN), a virtual private network (VPN), intranet or other suitable network system and may include equipment for receiving and transmitting signals. Network 116 may be a mobile phone network.

I/O interface 112 may serve to output processed data to an output device connected to computer system 101 and to receive data entry from an input device, both devices shown generically in the figure as I/O device 114. I/O device 114 may include a display, a conventional keyboard and mouse, a scanner, a printer, an imaging device, a microphone, among many other devices which may serve to either output processed data or may be used for data entry. I/O device 114 may further include devices that communicate both inputs and outputs, for example, a network interface card (NIC) or a modulator/demodulator, a radio frequency (RF) or other transceiver, a telephonic interface, a bridge, a router, and the like.

Reference is now made to FIG. 2 which schematically illustrates NE 102, according to an embodiment of the present invention. NE 102 may include a GUI generator 202, a market tracker 204, an action generator 206, a suggestion unit 207, a memory 208, a processor 210, and a database 212.

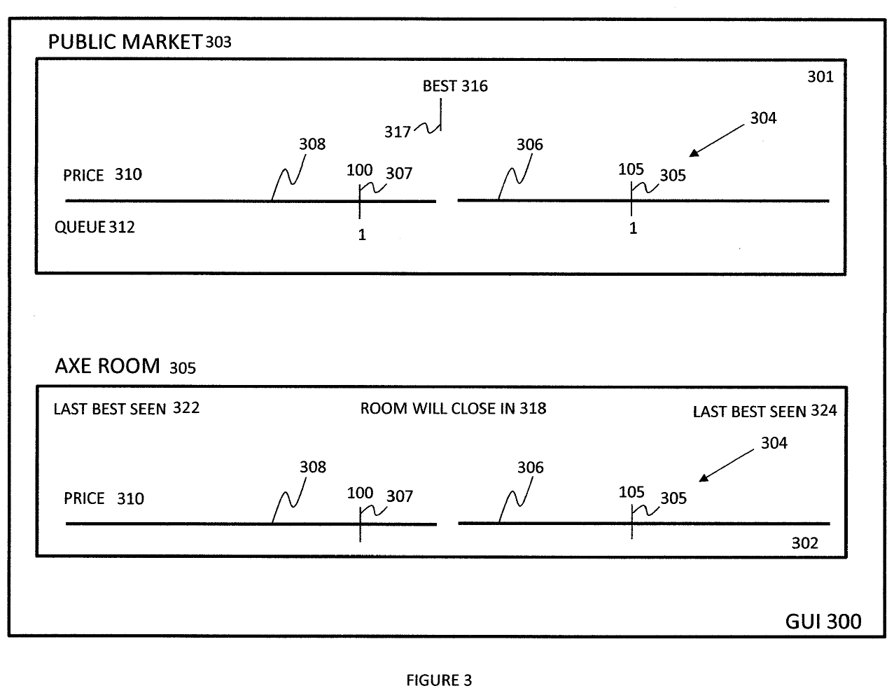

GUI generator 202 may generate the GUIs in the computing devices of all ANS users. It may generate the data displayed by the GUIs and may process data input by a user through the user's computing device GUI for display on the GUIs of the other users' computing devices. It may also serve to interface between the GUIs of the computing devices and the other components in NE 200, including market tracker 204, action generator 206 and suggestion unit 207. A description of an exemplary GUI is provided further on below with reference to FIG. 3.

Market tracker 204 may interface with GUI generator 202 to track all buyer and seller offers, to update offers, and to retain previous offers, all of which may be displayed to all the users through their computing device GUI. Market tracker 204 may additionally track real-time prices product and services from external market sources, for example, from securities and financial instruments markets, currency markets, commodities markets, food markets, among others. Market tracker 204 may provide the external market information to GUI generator 202 which may display the information to all the users through their computing device GUI. Market tracking information used by market tracker 204 may be internally stored inside the market tracker or alternatively, may be stored in database 212. The stored market information may be retained permanently, or may be stored for a predetermined amount of time, for example, until the end of a trading day, for a week, a month, a year, or longer.

Action generator 206 may also interface with GUI generator and may process negotiation actions received from users and may generate the notifications which may be displayed on the GUI axis of the computing device. The negotiation actions may be input by the users through their computing device GUI and, based on the type of action, action generator 206 may instruct GUI generator 202 to display the respective notification on the GUI of all user computing devices or only some of the computing device (for example on two computing devices, one of the highest price buyer and one of the lowest price seller).

Suggestion unit 207 may select potential match parties with the higher score and suggest them to a requesting party. Suggestion unit 207 may also consider when selecting the potential match parties' information associated with the requesting party and/or the potential matching parties and which may include behavioral data for each user stored in database 212. Other information which may be considered in suggesting the matching may be historical data associated with past operations performed by each user and also accumulated in data database 212. Additional information which may be considered is other external user data stored in database 212 described further on below, among other information.

Processor 208 may control the operation, including the interfacing, of all components in NE 200 and may interface with processor 104 in computer system 101 for data transfer between the NE and other components of the computer system. In some embodiments, the functions carried out by processor 208 may be provided by processor 104. The instructions required by processor 208 to execute its control and interfacing functions may be stored in memory 210.

Database 212 may store market information which may include historical data per product type or service, including trading prices, user offers, deals closed, and actions taken by users, among other data which may be used in trading platforms and which may also be used to encourage negotiations between users. Database 212 may additionally include details associated with each AINS user, for example, user registration information, user authentication information, user payment information, user transaction information, among other user information generally collected in subscriber-based on-line trading platforms. The information in database 212 may be updated continuously or periodically.

Reference is now also made to FIG. 3 which schematically illustrates an exemplary layout for GUI 300 which may be used with all AINS 100 user computing devices, according to an embodiment of the present invention. GUI 300 may be operatively similar to that described in the abovementioned applications which are common to the Applicant and which their contents is incorporated herein by reference in their entirety. GUI 300 may include a display section labelled PUBLIC MARKET 303 which may include an axis-display window 301 and may also include a section labelled AXE ROOM 305 which may include an axis-display window 302. The information displayed in PUBLIC MARKET 303 may be viewed by all the buyers and sellers (all system users, the public market) while that displayed in AXE ROOM 305 may only be viewed by those buyers and sellers in the Axe Room and who appear on axis-window 302, as will be described further on below.

Axis display windows 301 and 302 may each include an axis 304 which may be used to graphically display information related to offers and demands made by buyers and sellers, respectively, associated with a specific product or service. Axis 304 may be divided into two sections, a section 306 and an opposing section 308. Section 306 may display sales demands (hereinafter “offers”) made by sellers and section 308 may display buying offers (hereinafter “bids”) made by buyers. The offers may be shown by ticks in section 306, for example tick 305 which may be associated with a particular offer made by a specific seller, and the bids by ticks in section 308, for example tick 307, which may be associated with a particular bid made by a specific buyer. Above tick 305 may be displayed a seller's offer, for example 105, and above tick 307 may be displayed a buyer's bid, for example 100. It may be appreciate the axis section may show multiple ticks associated with multiple buyers and sellers.

In axis-window 301, below tick 305 may be displayed the number of sellers who offered the same price, for example 1 indicating that there are no other sellers selling at the same price, and the number of buyers bidding to buy at the same price is also shown below tick 307, again in this example 1. Axis 304 in axis-window 301 may additionally include labels to assist the user to better interpret the information above and below the ticks, for example, PRICE 310 above axis 304, and QUEUE 312 below the axis.

Also displayed in axis-window 301 may be the highest bid presently in the public market and the lowest offer in the market below the label BEST 316, the best bid to the left of line 317 (corresponding with axis section 308) and the best offer to the right of line 317 (corresponding with axis section 306). The best prices shown may vary as deals are closed and buyers and sellers leave the market, or as new buyers and sellers enter the market with new bids and offers or as the buyers and sellers revise their bids and offers publicly.

In axis-window 302, additional information which may be displayed may include an amount of time remaining for a buyer and a seller inside the Axe Room to negotiate a deal before the room closes, as indicated by ROOM WILL CLOSE IN 318. Other information may include the best bid made by the buyer in the Axe Room as indicated by LAST BEEN SEEN 322 and which may optionally include how much time has passed since the bid was made, and the best offer made by the seller as indicated by LAST BEEN SEEN 324 and which may also optionally include how much time has passed since the offer was made.

It may be appreciated by the skilled person that the GUI layout shown in FIG. 3 above, and following in FIGS. 4A-4H and 5A-5F, below are for exemplary purposes and are not intended to be limiting in any manner or form. In some embodiments, the GUI may be modified to include more or less displayed information, or different type of information depending on the product or service being traded, or that the arrangement used for information display may differ from that shown in the layout. Additionally, although not shown in the figures, the GUI may provide means to allow the users to enter data including bids and offers, and to generate actions to allow buyers and sellers to interface with one another, including carrying out negotiation actions. The skilled person may additionally realize that the axes do not necessarily have to be positioned horizontally and may be positioned vertically or at an angle, with one section used to display offers and the opposing section used to display bids. The skilled person may further realize that it may not be important which section of an axis is used to display the offers and which section is used to display the bids so long as the offers and the bids are displayed in separate opposing sections of the axis with their corresponding information clearly distinguishable.

Reference is now made to FIGS. 4A to 4H and 5A to 5F which schematically illustrate the operation of AINS 100 in exemplary trading sessions which include negotiations between 4 participants in the Axe Room, as visualized on GUI 300 of the users, according to an embodiment of the present invention. The figures are intended to show the operation of the AINS with different possible scenarios which may occur during a trading session and are not intended to be limiting in any way or form. The skilled person will immediately realize that there may be a countless number of scenarios which may occur during trading sessions involving multiple market players and that the AINS may be used in all of these scenarios. The exemplary trading session is described hereinbelow with reference to trading of financial instruments, although the trading session may be applied to any type of product which may be exchanged between two parties, for example, by buying and selling, by barter, or by any other known type of commercial exchange transaction.

In FIGS. 4A-4H, as well as in FIGS. 5A-5F, further on below, for exemplary purposes, all scenarios involve four participants identified as A, B, C, and D. The bids or offers made by the participants are identified on the axes by each participant's identification placed above the price. For example, in FIG. 4A, the letter “A” above the price of “2.5” in axis section 308 in AXE ROOM 305 is indicative of that being A's bid (or the offer if on axis section 306) in the Axe Room. The inclusion of the participants identifications in the figures has been done for clarity purposes to allow the reader to associate each bid or offer in a scenario with its respective participant. Nevertheless, in reality, in the actual GUI display of each participant, the identity of participants are not identified to the other participants and only the prices and other information associated with the bids or offers may be displayed.

All bids or offers in the Axe Room are visible to all participants in the Axe Room and not to the Public Market, unless an Axe Room participant requests to also be displayed to the Public Market. All bids and offers in the Public Market are visible to all participants in the Axe Room. For reader clarity, each figure includes an indication as to which participants can see the information displayed through the GUI for a particular scenario. This indication may be found next to part identification number GUI 300. For example, in FIG. 4A, GUI 300—DISPLAY A indicates that only A can view the information displayed for that particular scenario. A figure with GUI—DISPLAY A, C indicates that only A and C can see the information displayed for the particular scenario.

First Exemplary Trading Session

In FIG. 4A, in a first scenario in the trading session, A may place a bid in the Axe Room to purchase at a price of 2.5 a financial instrument (hereinafter referred to as “product”). The bid may be placed through GUI 300 on A's computing device, and may be displayed only on A's computing device GUI as the bid was placed in the Axe Room and there are no other participants in the Axe Room. AXE ROOM 305 of GUI 300 in A's computing device may open and the bid may be shown as a tick on axis-section 308 with the number 2.5 above the tick indicative of the price. Trade Spread TS 402, represented by the double headed arrow, may be predetermined based on the product being traded, and may be a buyer spread as A is a buyer. Alternatively, A may define TS 402 and may input the TS through GUI 300 or otherwise through other means. PUBLIC MARKET 303 may display no prices as the bid was placed in the Axe Room and not in the Public Market and there is no previous activity in the Public Market.

In FIG. 4B, in a second scenario in the trading session, B may place an offer in the Axe Room to sell the product at a price of 4. The offer may be placed through GUI 300 on B's computing device, and may be displayed only on B's computing device GUI as the offer was placed in the Axe Room but is outside TS 402 (B cannot enter the Axe Room). AXE ROOM 305 of GUI 300 in B's computing device may open and the offer may be shown as a tick on axis-section 306 with the number 4 above the tick indicative of the price but may not show A's bid. Alternatively, AXE ROOM 305 may not open as the offer is outside TS 402 and the offer may be otherwise indicated through GUI 300—DISPLAY B. PUBLIC MARKET 303 may display no prices as the offer was placed in the Axe Room and there is no previous activity in the Public Market.

In FIG. 4C, in a third scenario in the trading session, C may place an offer in the Axe Room to sell the product at a price of 3.5. The offer may be placed through GUI 300 on C's computing device and may be displayed on C's computing device GUI as well as on A's computing device GUI as the offer was placed in the Axe Room and is within TS 402. AXE ROOM 305 in GUI 300—DISPLAY A and GUI 300—DISPLAY C in A's computing device and C's computing device, respectively, may show the bid as a tick on axis-section 308 with the number 2.5 above the tick and the offer as a tick on axis-section 306 with the number 3.5 above the tick. The identification of A may not be shown on C's display and the identification of C may be not shown on A's display to maintain the parties in anonymity. Also displayed in AXE ROOM 305 under LAST BEST SEEN 322 may be the bid 2.5 and under LAST BEST SEEN 324 the offer 3.5. Additionally displayed may be the amount of time remaining before the Axe Room closes (negotiation time) to A and C under ROOM WILL CLOSE IN 318, for example 04:53 minutes. PUBLIC MARKET 303 may display no prices as the bid was placed in the Axe Room and there is no previous activity in the Public Market.

In FIG. 4D, in a fourth scenario in the trading session, responsive to C entering the Axe Room and viewing the offer at 3.5, A may improve its bid to 2.7. AXE ROOM 305 in GUI 300—DISPLAY A and GUI 300—DISPLAY C in A's computing device and C's computing device, respectively, may show the improved bid as a tick on axis-section 308 with the number 2.7 above the tick and the offer as a tick on axis-section 306 with the number 3.5 above the tick. TS 402 may optionally shift together with A's improved bid. Also displayed in AXE ROOM 305 under LAST BEST SEEN 322 may be the improved bid 2.7 and under LAST BEST SEEN 324 the offer 3.5. Additionally displayed may be the Axe Room timer which shows the amount of time remaining before the Axe Room closes to A and C under ROOM WILL CLOSE IN 318, which was reset to start at 05:00 minutes due to the improved bid, for example 04:57 minutes. PUBLIC MARKET 303 displays no prices as the bid was placed in the Axe Room and there is no previous activity in the Public Market.

In FIG. 4E, in a fifth scenario in the trading session, following the Axe Room timer having been reset to 05:00 minutes due to the improved bid by A, neither A nor C have moved on either the improved bid or the offer. As none of the parties have improved their position within a predetermined amount of time since the start of the negotiation, for example, for one minute as evidenced by Axe Room timer which now shows 04:00 minutes under WILL CLOSE IN 318, negotiation engine 102, in order to advance the negotiation process, may broadcast the existence of the Axe Room to the Public Market (all system users) by displaying a message on the GUI on all computing devices. A message MESSAGE: YOU ARE IN AXE ROOM; MARKET IS AWARE IT EXISTS! 410 may be displayed on GUI 300—DISPLAY A and GUI 300—DISPLAY C in A's computing device and C's computing device, respectively. In the broadcast, neither the identities of A and C nor the bid price nor the offer price may be exposed.

In FIG. 4F, in a sixth scenario, following the broadcast of MESSAGE 410 alerting the whole market that the Axe Room exists, B, who previously offered 4 and is now aware of the Axe Room's existence, may make an offer to enter the Axe Room and enters at a price of 3.4. AXE ROOM 305 in GUI 300—DISPLAY A in A's computing device, GUI 300—DISPLAY B in B's computing device, and GUI 300—DISPLAY C in C's computing device, respectively, may show the improved offer as a tick on axis-section 306 with the number 3.4 above the tick and the existing A bid as a tick on axis-section 308 with the number 2.7 above the tick and the existing C offer as a tick on axis-section 306 with the number 3.5 above it. By allowing C to view the improved offer made by B, C may be incited to improve B's offer. Also displayed in AXE ROOM 305 under LAST BEST SEEN 322 may be the bid 2.7 and under LAST BEST SEEN 324 the improved offer 3.4. Additionally displayed may be the Axe Room timer which may show the amount of time remaining before the Axe Room closes to A, B and C under ROOM WILL CLOSE IN 318, which may be reset to start at 05:00 minutes due to the improved offer, for example 04:56 minutes. PUBLIC MARKET 303 may display no prices as the bid was placed in the Axe Room and there is no previous activity in the Public Market. MESSAGE 410 may continue to be displayed to the Public Market.

In FIG. 4G, in a seventh scenario, with the whole market aware that the Axe Room is open, D may make a public offer of 3.4. The offer may be shown to the Public Market through GUI 300 of all user computing devices as a tick with the number 3.4 above it and the number 1 below it in axis-section 306 in PUBLIC MARKET 303. The 1 below the tick is indicative that this in the only price offer at 3.4. The offer may also be shown below and to the right (offer side) of BEST 316. As the offer made by D matches the offer made by B, negotiation engine 102 may automatically enter D's offer into the Axe Room. AXE ROOM 305 in GUI 300—DISPLAY A, GUI 300—DISPLAY B, GUI 300—DISPLAY C and GUI 300—DISPLAY D in A's computing device, B's computing device, C's computing device, and D's computing device, respectively, may show D's offer, which is the same as B's offer, as the same tick on axis-section 306 with the number 3.4 above the tick. A's existing bid is shown as a tick on axis-section 308 with the number 2.7 above the tick and C's existing offer of as a tick on axis-section 306 with the number 3.5 above it. Also displayed in AXE ROOM 305 under LAST BEST SEEN 322 may be the bid 2.7 and under LAST BEST SEEN 324 the improved offer 3.4. Additionally displayed may be the Axe Room timer which may show the amount of time remaining before the Axe Room closes to A, B, C and D under ROOM WILL CLOSE IN 318, and which may continue to count as D's offer is not a better offer than the existing offer made by B in the Axe Room, for example 04:25 minutes. PUBLIC MARKET 303 may display D's offer (to the whole market). MESSAGE 410 may continue to be displayed to the Public Market.

In FIG. 4H, in an eight scenario, having entered the Axe Room and viewing A's bid, D may make a public offer to match the bid at a price of 2.7. The offer may be shown to the Public Market through GUI 300 of all user computing devices as a tick with the number 2.7 above it and the number 1 below it in axis-section 306 in PUBLIC MARKET 303. The offer may be also shown below and to the right (offer side) of BEST 316. As the offer made by D matches the bid made by A, the negotiation is finished and the Axe Room closes. A's bid, and B's, C's, and D's offers may be broadcasted to the whole market by displaying their prices in axis-section 306 in PUBLIC MARKET 303.

Second Exemplary Trading Session

In FIG. 5A, in a first scenario in the trading session, A may place a bid in the Axe Room to purchase at a price of 2.5 a financial product. The bid may be placed through GUI 300 on A's computing device, and may be displayed only on A's computing device GUI as the bid was placed in the Axe Room and there are no other participants in the Axe Room. AXE ROOM 305 of GUI 300 in A's computing device may open and the bid may be shown as a tick on axis-section 308 with the number 2.5 above the tick indicative of the price. Trade Spread TS 402, represented by the double headed arrow, may be predetermined based on the product being traded, and may be a buyer spread as A is a buyer. Alternatively, A may define TS 402 and may input the TS through GUI 300 or otherwise through other means. PUBLIC MARKET 303 may not display any prices as the bid was placed in the Axe Room and there is no previous activity in the Public Market. TS 402 may be computed for A's bid.

In FIG. 5B, in a second scenario in the trading session, B may place an offer in the Axe Room to sell the product at a price of 3.3. The offer may be placed through GUI 300 on B's computing device and may be displayed on B's computing device GUI as well as on A's computing device GUI as the offer was placed in the Axe Room and is within TS 402. AXE ROOM 305 in GUI 300—DISPLAY A and GUI 300—DISPLAY B in A's computing device and B's computing device, respectively, may show A's bid as a tick on axis-section 308 with the number 2.5 above the tick and B's offer as a tick on axis-section 306 with the number 3.3 above the tick. The identification of A may not be shown on B's display and the identification of B may not be shown on A's display to maintain the parties in anonymity. Also displayed in AXE ROOM 305 under LAST BEST SEEN 322 may be the bid 2.5 and under LAST BEST SEEN 324 the offer 3.3. Additionally displayed may be the amount of time remaining before the Axe Room closes to A and B under ROOM WILL CLOSE IN 318, for example 04:55 minutes. PUBLIC MARKET 303 may not display any prices as the bid was placed in the Axe Room and there is no previous activity in the Public Market.

In FIG. 5C, in a third scenario, C may make a public bid of 2.5. The bid may be shown to the whole market through GUI 300 of all user computing devices as a tick with the number 2.5 above it and the number 1 below it in axis-section 308 in PUBLIC MARKET 303. The 1 below the tick may be indicative that this in the only price bid at 2.5 in the Public Market. The bid may also be shown below and to the left (bid side) of BEST 316. As the bid made by C matches the bid made by A, negotiation engine 102 may automatically enter C's bid into the Axe Room. AXE ROOM 305 in GUI 300—DISPLAY A, GUI 300—DISPLAY B, and GUI 300—DISPLAY C in A's computing device, B's computing device, and C's computing device respectively, may show C's bid which is the same as A's bid as the same tick on axis-section 308 with the number 2.5 above the tick and B's bid as a tick on axis-section 306 with the number 3.3 above the tick. Also displayed in AXE ROOM 305 under LAST BEST SEEN 322 may be the bid 2.5 and under LAST BEST SEEN 324 the offer 3.3. Additionally displayed may be the Axe Room timer which may show the amount of time remaining before the Axe Room closes to A, B, and C under ROOM WILL CLOSE IN 318, and which may continue to count as C's bid in not better than the existing bid made by A in the Axe Room, for example 04:41 minutes. PUBLIC MARKET 303 may display C's offer (to the whole market).

In FIG. 5D, in a fourth scenario, D may make a public offer of 3.5. The offer may be shown to the whole market (Public Market) through GUI 300 of all user computing devices as a tick with the number 3.5 above it and the number 1 below it in axis-section 306 in PUBLIC MARKET 303. The 1 below the tick may be indicative that this in the only price offer at 3.5 in the Public Market. The offer may also be shown below and to the right (offer side) of BEST 316. D's offer is outside of TS 402 and the Axe Room does not open. AXE ROOM 305 in GUI 300—DISPLAY A, GUI 300—DISPLAY B, and GUI 300—DISPLAY C in A's computing device, B's computing device, and C's computing device respectively, may continue to display the same information as there has been no change in the bid prices nor in the offer price. Axe Room timer may continue to run, as shown by ROOM WILL CLOSE IN 318 which may show, for example 04:35 minutes. D's GUI may not show the A's, B's, and C's prices in AXE ROOM 305 as D has not entered the Axe Room.

In FIG. 5E, in a fifth scenario, D improves the public offer to 3.2 as shown in PUBLIC SECTION 303 in axis-section 306 by the tick with the number 3.2 above it. As the public offer is within TS 402, the seller is automatically entered into the Axe Room. AXE ROOM 305 in GUI 300—DISPLAY A, GUI 300—DISPLAY B, GUI 300—DISPLAY C, and GUI 300—DISPLAY D in A's computing device, B's computing device, Cs computing device and D's computing device, respectively, may show the offer as a tick on axis-section 306 with the number 3.2 above the tick. A and C's bids may be shown as a tick on axis-section 308 with the number 2.5 above the tick and B's offer on axis-section 306 as a tick with the number 3.3 above it. By allowing all participants to view the bids and the offer made by D, B may be incited to improve its offer as well as A and/or C. Also displayed in AXE ROOM 305 under LAST BEST SEEN 322 may be the bid 2.5 and under LAST BEST SEEN 324 the improved offer 3.2. Additionally displayed may be the Axe Room timer which may show the amount of time remaining before the Axe Room closes to A, B, C and D under ROOM WILL CLOSE IN 318, which was reset to start at 05:00 minutes due to the improved offer, for example 04:54 minutes. PUBLIC MARKET 303 may show C's bid of 3.5 and D's offer of 3.2.

Unless specifically stated otherwise, as apparent from the preceding discussions, it is appreciated that, throughout the specification, discussions utilizing terms such as “processing,” “computing,” “calculating,” “determining,” or the like, refer to the action and/or processes of a general purpose computer of any type such as a client/server system, mobile computing devices, smart appliances or similar electronic computing device that manipulates and/or transforms data represented as physical, such as electronic, quantities within the computing system's registers and/or memories into other data similarly represented as physical quantities within the computing system's memories, registers or other such information storage, transmission or display devices.

Embodiments of the present invention may include apparatus for performing the operations herein. This apparatus may be specially constructed for the desired purposes, or it may comprise a general-purpose computer selectively activated or reconfigured by a computer program stored in the computer. The resultant apparatus when instructed by software may turn the general purpose computer into inventive elements as discussed herein. The instructions may define the inventive device in operation with the computer platform for which it is desired. Such a computer program may be stored in a computer readable storage medium, such as, but not limited to, any type of disk, including optical disks, magnetic-optical disks, read-only memories (ROMs), volatile and non-volatile memories, random access memories (RAMs), electrically programmable read-only memories (EPROMs), electrically erasable and programmable read only memories (EEPROMs), magnetic or optical cards, Flash memory, disk-on-key or any other type of media suitable for storing electronic instructions and capable of being coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A computer-implemented method of negotiating a trade of a product or a service between a buyer and a seller, the method comprising:
receiving from a buyer computing device a bid associated with the product or service;
assigning to said bid a trade spread based on a predetermined criteria;
receiving from one or more seller computing devices offers associated with the product or service;
classifying each of said offers lying within said trade spread as a tradeable offer;
transmitting said buyer bid and each tradeable offer to said buyer computing device and to each seller computing device with a tradeable offer;
automatically displaying said buyer bid and each tradeable offer on said buyer computing device and on each seller computing device with a tradeable offer; and
tracking the time said buyer bid and a tradeable offer most approximating said buyer bid are displayed on said buyer computing device and on each seller computing device with a tradeable offer.

2. A method according to claim 1 further comprising broadcasting a message that a negotiation is ongoing between an anonymous buyer and an anonymous seller to a plurality of buyer and seller computing devices when said tracked time reaches a predetermined time.

3. A method according to claim 2 comprising displaying a message associated with said broadcasted message on said buyer computing device and on each seller computing device with a tradeable offer.

4. A method according to claim 1 wherein said trade spread comprises a predetermined price range associated with a specific product or service.

5. A method according to claim 1 further comprising broadcasting said buyer bid and each tradeable offer to a plurality of buyer and seller computing devices when said tracked time reaches a predetermined time.

6. A method according to claim 1 further comprising resetting the tracked time when a new tradeable offer is received which is closer to the buyer in said tradeable spread relative to previously received tradeable offers.

7. A method according to claim 1 further comprising broadcasting said buyer bid and each tradeable offer to a plurality of buyer and seller computing devices when a tradeable offer matches said buyer bid.

8. A method according to claim 1 further comprising maintaining an anonymity of said buyer computing device and said seller computing devices.

9. A negotiation system comprising:
a negotiation engine; and
a non-transitory computer readable medium storing instructions executable in said negotiation engine and causing said negotiation engine to perform operations comprising:
a) receiving from a buyer computing device a bid associated with the product or service;
b) assigning to said bid a trade spread based on a predetermined criteria;
c) receiving from one or more seller computing devices offers associated with the product or service;
d) classifying each of said offers lying within said trade spread as a tradeable offer;
e) transmitting said buyer bid and each tradeable offer to said buyer computing device and to each seller computing device with a tradeable offer;
f) automatically displaying said buyer bid and each tradeable offer on said buyer computing device and on each seller computing device with a tradeable offer; and
g) tracking the time said buyer bid and a tradeable offer most approximating said buyer bid are displayed on said buyer computing device and on each seller computing device with a tradeable offer.

10. A system according to claim 9 wherein said instructions further cause said negotiation engine to broadcast a message that a negotiation is ongoing between an anonymous buyer and an anonymous seller to a plurality of buyer and seller computing devices when said tracked time reaches a predetermined time.

11. A system according to claim 10 wherein said instructions further cause said negotiation engine to display a message associated with said broadcasted message on said buyer computing device and on each seller computing device with a tradeable offer.

12. A system according to claim 9 wherein said trade spread comprises a predetermined price range associated with a specific product or service.

13. A system according to claim 9 wherein said instructions further cause said negotiation engine to broadcast said buyer bid and each tradeable offer to a plurality of buyer and seller computing devices when said tracked time reaches a predetermined time.

14. A system according to claim 9 wherein said instructions further cause said negotiation engine to reset the tracked time when a new tradeable offer is received which is closer to the buyer in said trade spread relative to previously received tradeable offers.

15. A system according to claim 9 wherein said instructions further cause said negotiation engine to broadcast said buyer bid and each tradeable offer to a plurality of buyer and seller computing devices when a tradeable offer is the same as said buyer bid.

16. A system according to claim 9 wherein said instructions further cause said negotiation engine to maintain an anonymity of said buyer computing device and said seller computing devices.

17. A non-transitory computer readable medium for use in negotiations and storing instructions executable in a negotiation engine and causing said negotiation engine to perform operations comprising:
a) receiving from a buyer computing device a bid associated with the product or service;
b) assigning to said bid a trade spread based on a predetermined criteria;
c) receiving from one or more seller computing devices offers associated with the product or service;
d) classifying each of said offers lying within said trade spread as a tradeable offer;
e) transmitting said buyer bid and each tradeable offer to said buyer computing device and to each seller computing device with a tradeable offer;
f) automatically displaying said buyer bid and each tradeable offer on said buyer computing device and on each seller computing device with a tradeable offer; and
g) tracking the time said buyer bid and a tradeable offer most approximating said buyer bid are displayed on said buyer computing device and on each seller computing device with a tradeable offer.

18. A storage medium according to claim 17 wherein said instructions further cause said negotiation engine to broadcast a message that a negotiation is ongoing between an anonymous buyer and an anonymous seller to a plurality of buyer and seller computing devices when said tracked time reaches a predetermined time.

19. A storage medium according to claim 18 wherein said instructions further cause said negotiation engine to display a message associated with said broadcasted message on said buyer computing device and on each seller computing device with a tradeable offer.

20. A storage medium according to claim 17 wherein said trade spread comprises a predetermined price range associated with a specific product or service.

21. A storage medium according to claim 17 wherein said instructions further cause said negotiation engine to broadcast said buyer bid and each tradeable offer to a plurality of buyer and seller computing devices when said tracked time reaches a predetermined time.

22. A storage medium according to claim 17 wherein said instructions further cause said negotiation engine to reset the tracked time when a new tradeable offer is received which is closer to the buyer in said tradeable spread relative to previously received tradeable offers.

23. A storage medium according to claim 17 wherein said instructions further cause said negotiation engine to broadcast said buyer bid and each tradeable offer to a plurality of buyer and seller computing devices when a tradeable offer is the same as said buyer bid.

24. A storage medium according to claim 17 wherein said instructions further cause said negotiation engine to maintain an anonymity of said buyer computing device and said seller computing devices.
